(19) United States
(12) Patent Application Publication
(10) Pub. No.: US 2025/0327958 A1
(43) Pub. Date: Oct. 23, 2025

(54) POLARIZATION COMPENSATION FOR CORNER CUBE REFLECTOR

(71) Applicant: Arizona Board of Regents on Behalf of the University of Arizona, Tucson, AZ (US)

(72) Inventors: Sawyer MILLER, Tucson, AZ (US); Russell CHIPMAN, Tucson, AZ (US); Stanley PAU, Tucson, AZ (US)

(21) Appl. No.: 18/869,821

(22) PCT Filed: May 24, 2023
(86) PCT No.: PCT/US2023/023393

§ 371 Date: Nov. 26, 2024

Related U.S. Application Data
(60) Provisional application No. 63/365,348, filed on May 26, 2022.

(51) Int. Cl. G02B 5/30; G02B 5/122

(52) U.S. Cl. CPC G02B 5/3083; G02B 5/122

(57) ABSTRACT

Methods, systems and devices to compensate polarization aberration associated with a corner cube are described. One example retroflector system includes a corner cube reflector to receive input light and produce output light in six unique raypaths. Each raypath consists of three reflections of the input light before exiting the corner cube reflector. The retroflector system further includes a polarization compensator that includes six sub-apertures positioned to allow light associated with each unique raypath to enter one of the sub-apertures before entering the corner cube reflector and to exit another one of the sub-apertures after exiting the corner cube reflector. Each sub-aperture includes one or more layers of birefringent material and has a different fast axis compared to other sub-aperture. Each sub-aperture imparts a particular amount of polarization compensation such that exitant light has the same output polarization, regardless of which sub-aperture the light exits from.

### CROSS-REFERENCE TO RELATED APPLICATION(S)

This application claims priority to the provisional application with Ser. No. 63/365,348 titled “POLARIZATION COMPENSATION FOR CORNER CUBE REFLECTOR,” filed May 26, 2022. The entire contents of the above noted provisional application are incorporated by reference as part of the disclosure of this document.

### TECHNICAL FIELD

This description in this patent document relates to methods and devices for compensating polarization in a corner cube device.

### BACKGROUND

Corner cube reflectors are used extensively in many optical systems to redirect an incoming beam of light back toward its incoming direction. One advantage of the corner cube reflector is that it can reflect light at a range of angles of entry, making it an indispensable optical component for alignment. Another advantage is its small compact size, which can be tiled in an array to cover large areas. Applications of corner cube reflector include spectroscopy, road sign, free space optical communication, positioning, land survey, laser cavity, distance or time-of-flight measurement, interferometry, navigation and precision alignment.

### SUMMARY

The disclosed embodiments relate corner cubes and associated design procedures that allows improved polarization compensation characteristics when interacting with polarized light.

One example a retroflector system includes a corner cube reflector configured to receive input light and produce output light in six unique raypaths, where each raypath consists of three reflections of the input light from a corresponding combination of corner cube reflector surfaces before exiting the corner cube reflector. The retroflector system further includes a polarization compensator positioned in front of the corner cube reflector. The polarization compensator includes six sub-apertures that are positioned to allow light associated with each unique raypath to enter one of the sub-apertures before entering the corner cube reflector and to exit another one of the sub-apertures after exiting the corner cube reflector. Each sub-aperture comprises one or more layers comprising birefringent material, each sub-aperture has a different fast axis compared to any other sub-aperture, and each sub-aperture is configured to impart a particular amount of polarization compensation to the light that is incident thereon such that exitant light associated with all unique raypaths has the same output polarization, regardless of which sub-aperture the light exits from, when the input light that enters the polarization compensator has a first polarization.

### BRIEF DESCRIPTION OF THE DRAWINGS

FIG. 1 illustrates an example raypath through a corner cube and the polarization states of the incoming and outgoing rays.

FIG. 2 illustrates examples of raypaths for rays incident on and reflected from different facets of a corner cube and the associated polarization states.

FIG. 3 illustrates a superposition of six example combinations for the incoming light that is reflected from facets of a corner cube and the associated polarization states.

FIG. 4 illustrates a polarization compensator in conjunction with a corner cube prism reflector in accordance with an example embodiment.

FIG. 5 illustrates a retarder configuration with six sub-apertures in accordance with an example embodiment.

FIG. 6 illustrates an example ray diagram for an eight-degree cone of angles traced through the combination of a compensator and a corner cube reflector.

FIG. 7 illustrates a design prescription obtained in accordance with an example embodiment for a two-layer compensator allowing the compensated corner cube reflector to operate as a half-wave plate (HWP) oriented at 45 degrees.

FIG. 8 illustrates an example ray diagram corresponding to the combination of a compensator and a corner cube reflector based on the parameters of FIG. 7.

FIG. 9 illustrates a design prescription obtained in accordance with an example embodiment for a two-layer compensator where the combination of the two-layer compensator and corner cube act as a circular retarder with 180 degrees retardance.

FIG. 10 illustrates an example ray diagram corresponding to the combination of a compensator and a corner cube reflector based on the parameters of FIG. 9.

FIG. 11 illustrates an example ray diagram showing a 135-degree linearly polarized output resulting from an orthogonal 45-degree linear polarization at the input obtained based on the parameters of FIG. 9.

FIG. 12 illustrates a design prescription obtained in accordance with an example embodiment for details an example two-layer design which is completely non-polarizing such that the output polarization state is unchanged compared to the input polarization state.

FIG. 13 illustrates an example ray diagram corresponding to the combination of a compensator and a corner cube reflector based on the parameters of FIG. 12.

FIG. 14 illustrates a design prescription obtained in accordance with an example embodiment for a two-layer compensator allowing the compensated corner cube reflector to operate as a quarter-wave plate (QWP) oriented along the x-axis.

FIG. 15 illustrates an example a top view ray diagram traced through the corner cube at normal incidence for a configuration based on the parameters of FIG. 14, resulting in a circularly polarized output light.

FIG. 16 illustrates a first side view corresponding to the same raypaths as in FIG. 15.

FIG. 17 illustrates a second side view corresponding to the same raypaths as in FIG. 15.

FIG. 18 is a histogram illustrating the number of rays versus the degree of circular polarization (DoCP) corresponding to an example configuration.

FIG. 19 illustrates a set of polar plots of a Stokes parameter for each raypath, and for up to eight degrees angular incidence for an example configuration.

FIG. 20 is similar to FIG. 19 but has a reduced scale to show additional details.

FIG. 21 illustrates a multi-layer structure that includes an anti-reflection (AR) coating on top a uniaxial birefringent layer, which is placed above a reflective layer in accordance with an example embodiment.

### DETAILED DESCRIPTION

Another application of a corner cube is in counting objects. For example, a light source such as a light emitting diode (LED) can be directed toward a corner cube reflector; a detector positioned next to the light source can detect the reflected light. If the reflected light is interrupted due to an object blocking the beam's path (e.g., an object on a conveyer belt that passes in front of the path), the detection of the interrupted beam can be used to count the items that pass through the beam. Improving the design and operation of a corner cube improves the accuracy and effectiveness of such counting systems.

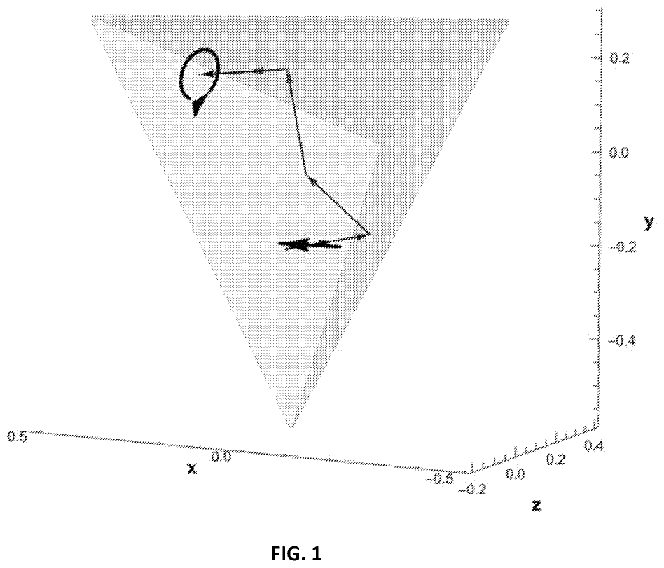

A corner cube reflector is made of three intersecting and perpendicular flat reflectors. There are generally two types: one that includes three flat mirrors, and another type that is formed as a three-sided glass prism. In both types, light is reflected by each surface three times, either by the mirrors or by total internal reflection (TIR) at the glass-air interfaces. As shown in FIGS. 1-3, there are six possible combinations for the incoming light to be reflected. The raypaths form pairs that go in both directions. After reflection, the light travels in the opposite and parallel direction to the incoming direction and is displaced.

One disadvantage of the corner cube reflector is the change of polarization state after the reflections which is caused by the reflections of light and by the change of its direction of propagation. The latter change component is geometric in nature. Both change components depend on the location and angle of entry. Generally, reflections from a metal-coated mirror result in a smaller polarization change than reflection from a glass prism. For applications where the preservation of the polarization state is critical, a corner cube reflector that does not change the polarization state of the incoming light is needed.

The disclosed embodiments relate to methods, devices and systems for design, construction and implementations of corner cube reflectors with precise polarization control. These and other features and benefits can be implemented in various embodiments using a compensation filter and/or coating. The polarization compensation filter includes at least one layer of patterned birefringent material. In some embodiments, the filter is used to preserve the polarization of the incoming light, such that the polarization of the reflected light is the same as the polarization of the incoming light for a range of angles of entry. In other embodiments, the filter is used to change the polarization of the incoming light to a predefined polarization, such that the polarization of the reflected light is equal to the predefined polarization for a range of angles of entry.

Referring to FIG. 1, this figure illustrates one of six unique raypaths through an example corner cube reflector. In this example, light is linearly polarized (represented by bold arrow in the middle of corner cube) along the x-axis and enters the corner cube (i.e., start of raypath at about y=−0.2). Light is then reflected three time before exiting the corner cube (i.e., top of the path); the output light, in this example, exhibits elliptical polarization (represented by the ellipse with a counter clockwise arrow). As shown by the double-sided arrows along the raypath direction, the raypath can be reversed (i.e., an elliptically polarized light entering the corner cube reflector from the top can undergo three reflections and result in a linearly polarized output light).

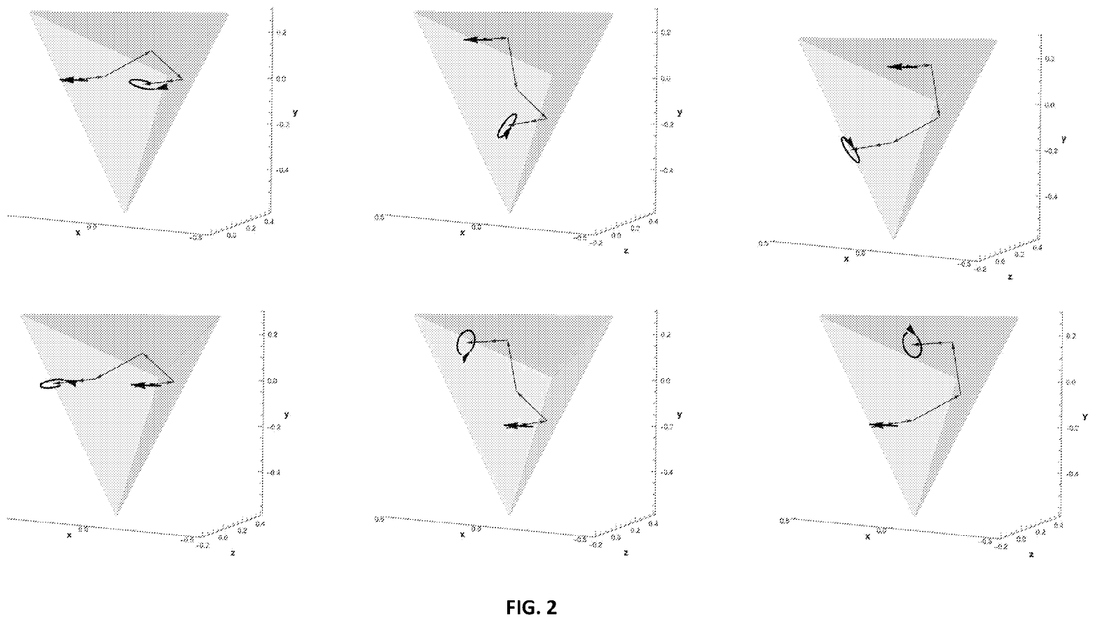

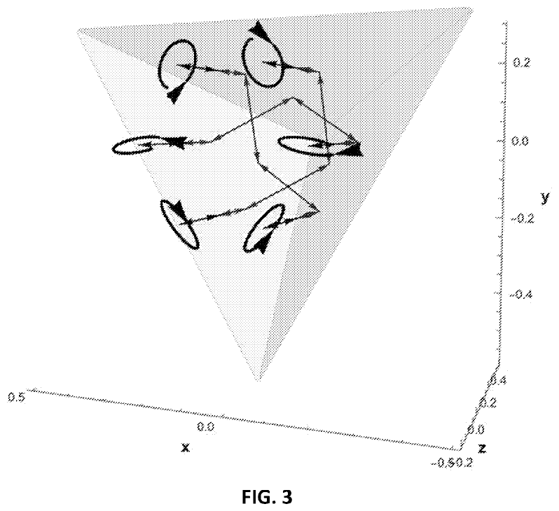

FIG. 2 illustrates all six unique raypaths through an example corner cube reflector. Light that is linearly polarized along the x-axis is input. As shown in FIG. 2, the polarization of output light is changed to elliptical polarization for all raypaths with differing ellipticities. FIG. 3 shows all six unique raypaths through the example corner cube reflector in one diagram. Linear polarization (along the x-axis) of the input light is changed to different elliptical polarizations for each raypath, demonstrating the difficulties in maintaining a consistent output polarization and the limited polarization control of the optical systems that utilize such corner cube reflectors.

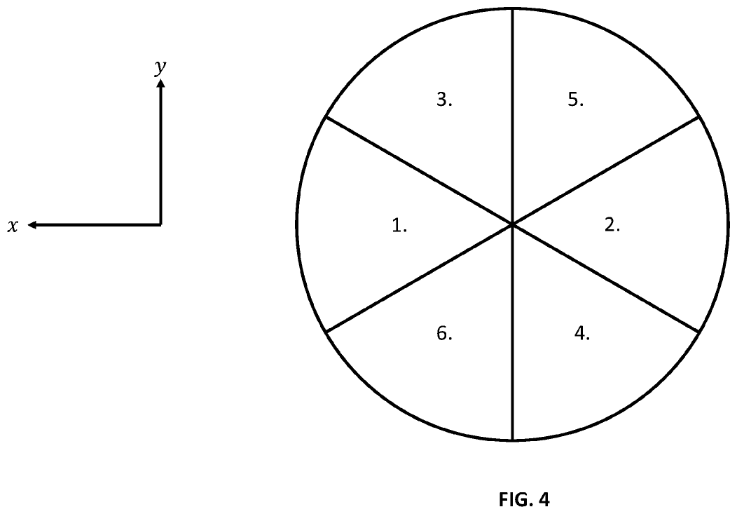

One embodiment of the polarization compensator in conjunction with a corner cube prism reflector is shown in FIG. 4. The compensator is divided into six pie-shaped areas of equal size. Each aperture slice corresponds to one of the six unique raypaths through the corner cube reflector. The numbering scheme in the depicted example is arbitrary and is used as an example to facilitate the description of the disclosed embodiments. In this example, light that enters sub-aperture 1, enters the corner cube reflector, is reflected three times before exits from sub-aperture 2 of the compensator. Similarly, entry-and-exit relationships exists for sub-apertures 3 and 4, and sub-apertures 5 and 6. Two of the areas are matched with one facet of the corner cube prism. All corner cubes utilize three facets for retroreflection. However, each facet will have two sub-apertures. This results in six unique raypaths and the division of the compensator into six unique raypaths. Each area is made of at least one layer of birefringent material. The fast and slow axes for the birefringent material have different orientations depending on the area. The exact orientation and thickness, i.e., retardance, of the birefringent material depend on the type of corner cube reflector, the refractive index of the material, the angle of entry, the wavelength of lights, and the input polarization and the desired output state of the light. Examples of the birefringent material include a liquid crystal polymer, a metamaterial, a birefringent crystal, uniaxial or biaxial material, and a form birefringent coating or a combination thereof. The material can be coated on a transparent substrate or on the facet of the prism. Example methods for the fabrication of patterned birefringent optical devices using liquid crystal polymer can be found in U.S. Pat. No. 8,866,997. In the sections that follow, example methods for determining an orientation and optical retardance of the coating are described. For simplicity, the case where the angle of entry is at a direct normal incident is considered. The described method can be generalized to other angles of entry or for a range of angles of entry by modification of the optimization function.

Polarization aberrations from the corner cube reflector utilizing TIR arise from two sources. Linear retardance from TIR is generated at each of the three reflections. Additionally, a retardance is generated from the geometric transform due to the propagation direction change in the corner cube reflector. Both sources of retardance cause the eigenstates of the six raypaths to be elliptical, as illustrated in the example diagrams of FIGS. 2 and 3 where the outputs of each unique raypath with normally incident horizontal linear polarization is elliptically polarized but with varying degrees of ellipticity.

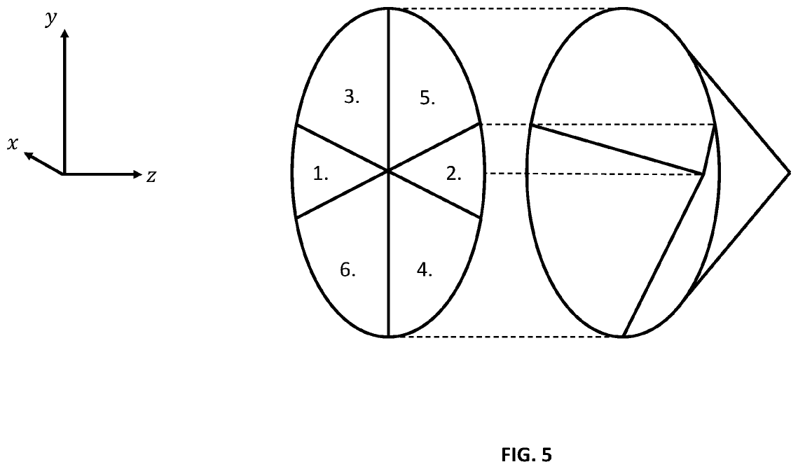

To compensate for this problem, an example design where a retarder with six sub-apertures is utilized as shown in FIG. 5. Each sub-aperture corresponds to a unique raypath through the corner cube reflector. The dashed line illustrates the alignment of the compensator with the corner cube reflector. The entire compensator plate includes a birefringent material with a constant thickness. However, each sub-aperture has a different fast-axis orientation, allowing for differing amounts of correction over the different sections of the aperture of the corner cube reflector. Of importance, is the flexibility in the technique to be applied to varying number of applications. Very simple layer designs can be realized if known input and output polarization states are used. Compensators consisting of only a single layer of birefringent material can be used in these applications. Inclusion of additional layers, each with a constant thickness, allows for a complete correction of all sub-apertures' Mueller matrices, increased achromatic performance, as well as increased angular performance.

An example design procedure for the of the compensator plate can be carried out a two-step process. First the optical system is input into a polarization tracking raytrace program, such as Polaris-M (Airy Optics Inc., Tucson, AZ). Each of the unique raypaths is traced, allowing for the calculation of a cumulative Mueller matrix for each. These Mueller matrices are then input into a constrained nonlinear multivariable solver, where the fast-axis and thickness, i.e., retardance, for each sub-aperture are calculated for the desired application. As an example, a two-layer compensator is designed, and input into the calculation of Eq. (1).

$$C = {\sum }_{m ∈ \{ 1 , 3 , 5 \}} ( LR ( {δ}_{1} , - {θ}_{2 m} ) \cdot LR ( {δ}_{2} , - {θ}_{2 m + 2} ) \cdot {M}_{m} \cdot LR ( {δ}_{2} , {θ}_{2 m + 1} ) \cdot LR ( {δ}_{1} , {θ}_{2 m - 1} ) - {M}_{T} ) + {\sum }_{n ∈ \{ 2 , 4 , 6 \}} ( LR ( {δ}_{1} , - {θ}_{2 n - 3} ) \cdot LR ( {δ}_{2} , - {θ}_{2 n - 1} ) \cdot {M}_{n} \cdot LR ( {δ}_{2} , {θ}_{2 n} ) \cdot LR ( {δ}_{1} , {θ}_{2 n - 2} ) - {M}_{T} ) \qquad ( 1 )$$

Here, LR is the Mueller matrix of a nematic A-plate operating as a linear retarder, dependent on both δ and θ. δ₁ and δ₂ are the linear retardances of the first and second layers, respectively, which are linearly proportional to the thicknesses of the corresponding layers. θ_{m,n} is the fast-axis angle (FA) for each of the six-apertures and layer. In total, for the two-layer design, there are 12 fast-axis angles and two thicknesses to be determined. M_{m,n} are the Mueller matrices calculated by the raytrace program for each of the six unique raypaths. Finally, M_{T} is the target Mueller matrix, i.e., the Mueller matrix corresponding to the desired operation of the combination of compensator plate and corner cube reflector. At the normal angle of incidence, S is calculated as:

$$δ = \frac{2 π Δ n d}{λ} \qquad ( 2 )$$

where Δn is the birefringence of the material, d is the thickness of the layer, and λ is the wavelength of incident light.

With the calculation of C in Eq. (1), the minimization of a scalar value (v) can be performed using, for example, Eq. (3), where v is equal to the Frobenius norm of the matrix C. Ideally, C will be a 4×4 matrix of zeroes if the solver is able to determine a good solution for compensation.

$$v = {‖ C ‖}_{F} = \sqrt{{\sum }_{i = 1}^{4} {\sum }_{j = 1}^{4} {\vert {c}_{i j} \vert}^{2}} \qquad ( 3 )$$

The alignment of the compensator plate to the corner cube reflector is shown in FIG. 5, where the numbered sub-apertures and coordinate system from FIG. 4 are used. All fast-axis angles are determined in the xy-plane, with angles referenced to the negative x-axis in the counter-clockwise direction as referenced to FIGS. 4 and 5.

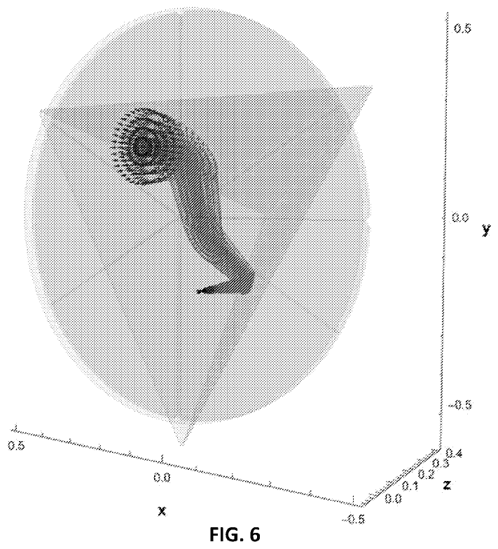

It is also desired to correct the polarization aberrations of the solid corner cube reflector at non-normal angles of incidence. The solid corner cube reflector has a finite angular acceptance. For example, at angles of incidence larger than 10 degrees, some raypaths do not meet the TIR critical angle and are transmitted out of the corner cube prism. In FIG. 6, an eight-degree cone of angles is traced through the combination of the compensator and the corner cube reflector, and the polarization states of the rays are analyzed. Additional explanations regarding the non-normal angles of incidence are provided in a later section of this patent document.

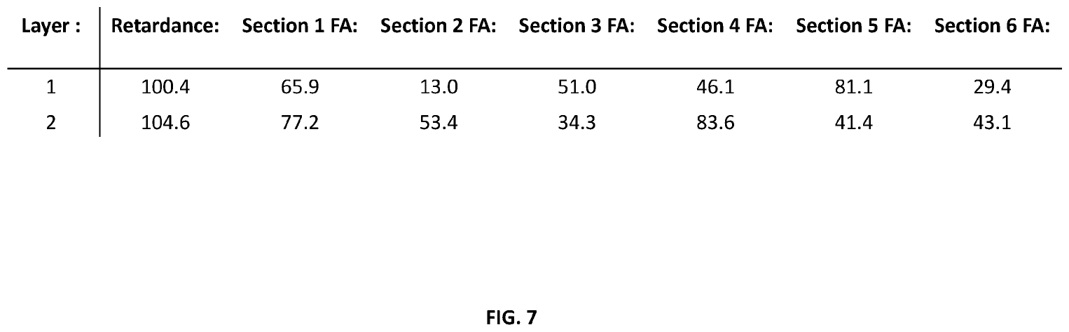

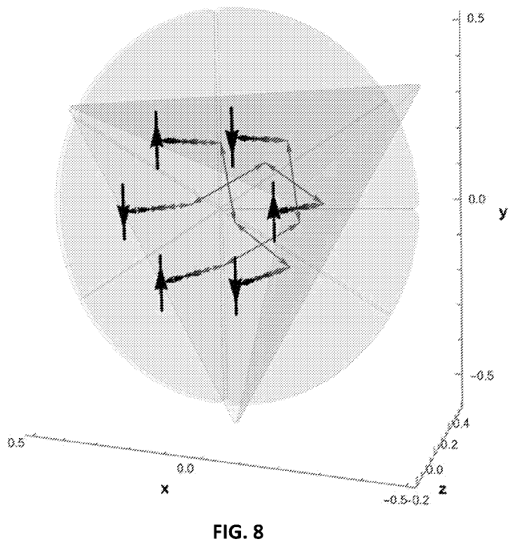

Utilizing Equations (1) and (3), two designs of the compensator and corner cube reflector are calculated, analyzed, and presented. In FIG. 7, the first design shows the prescription for a two-layer compensator allowing the compensated corner cube reflector to operate as a half-wave plate (HWP) oriented at 45 degrees between the x-axis and y-axis in the xy-plane. The design consists of two layers, with each sub-aperture having its own fast-axis alignment. The thickness for each layer is constant across all sub-apertures. The fast axis (FA) angles for each division and layer, along with the retardance for the layer, are shown in FIG. 7. To evaluate the effectiveness of the design, input linearly polarized light along the x-axis was traced through the compensator and corner cube reflector, as done in FIGS. 1-3. The result is shown in FIG. 8. In this example design, the input linear polarization state is rotated by 90 degrees and is polarized along the y-axis for all raypaths, satisfying the desired half-wave plate behavior. This can be compared with the configuration in FIGS. 1-3 without the compensator, where the output polarization states with varying degrees of ellipticity produce inconsistent and non-uniform results.

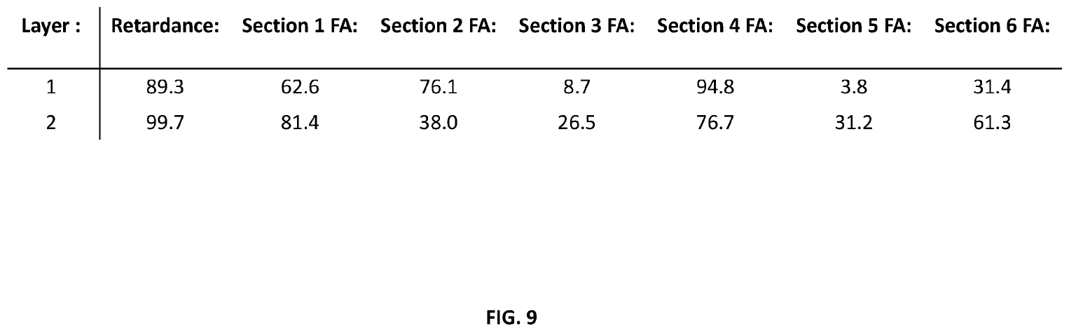

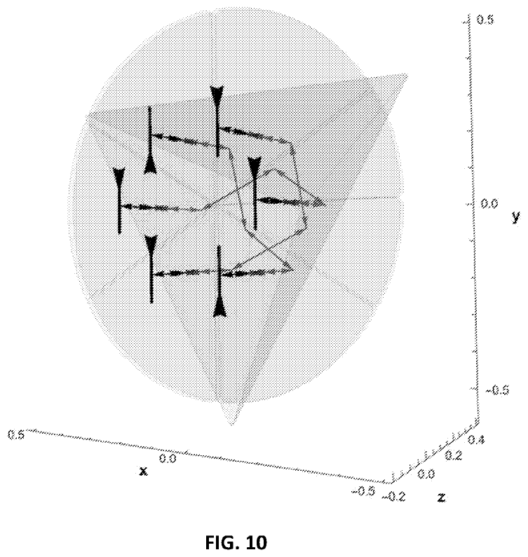

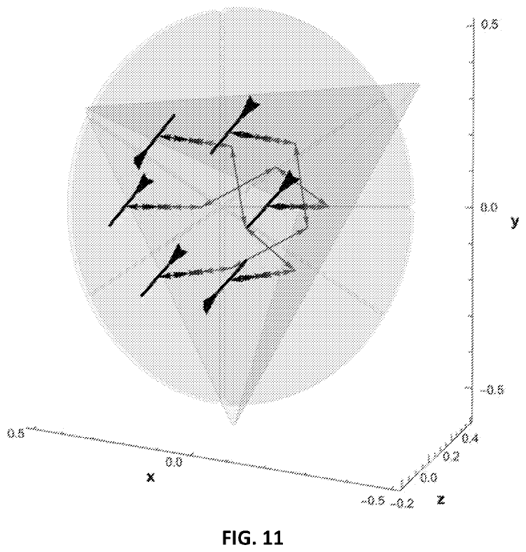

FIG. 9 details another example design where the combination of the two-layer compensator and corner cube act as a circular retarder with 180 degrees retardance. This condition with linearly polarized input light requires the output to be the orthogonal linear polarization to the input. Similar to the design in FIG. 7, the FIG. 9 design includes two layers, with each sub-aperture having its own fast-axis alignment. The thickness for each layer is constant across all sub-apertures. The fast axis angles for each division and layer, along with the retardance for the layer, are shown in FIG. 9. FIG. 10 shows the raytrace for each of the six unique raypaths through the solid corner cube reflector and the compensator with design characteristics of FIG. 9. Light that is linearly polarized along the x-axis is input for all raypaths. Each raypath outputs linearly polarized light along the y-axis satisfying the circular retarder, where the orthogonal polarization is output. FIG. 11 shows a 135-degree linearly polarized output resulting from the orthogonal 45-degree linear polarization being input. More specifically, FIG. 11 shows the raytrace for each of the six unique raypaths through the solid corner cube reflector and the compensator with design characteristics of FIG. 9. Light that is linearly polarized at 135 degrees is input for all raypaths. Each raypath outputs linearly polarized light at 45 degrees, satisfying the circular retarder, where the orthogonal polarization is output.

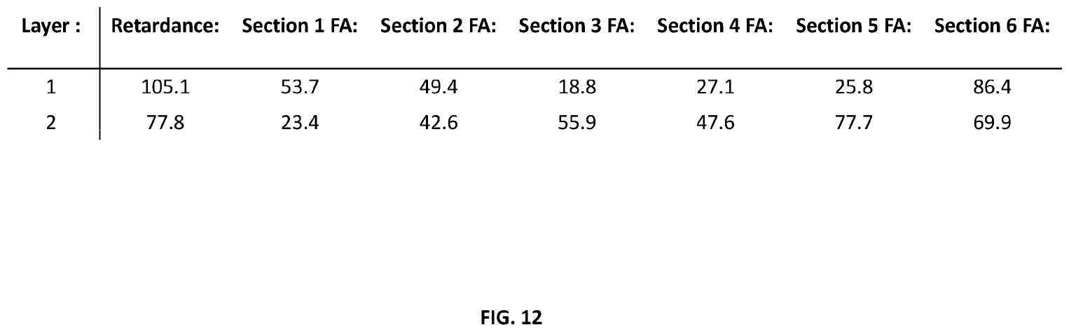

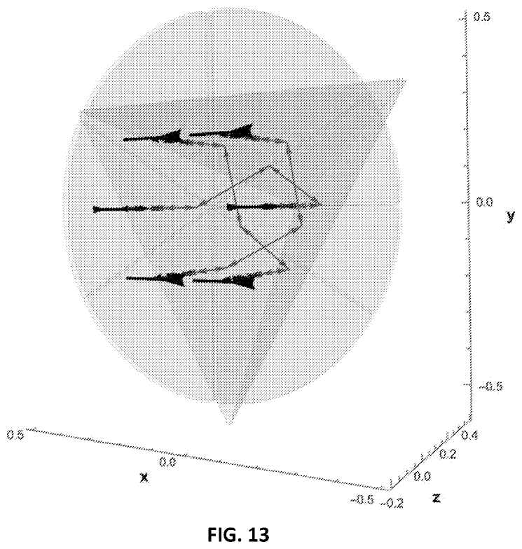

FIG. 12 details an example two-layer design which is completely non-polarizing; that is, the output polarization state is unchanged compared to the input polarization state. The Mueller matrix for each of the six raypaths can be described as an identity matrix, where the Stokes parameters are unchanged from input to output. The design consists of two layers, with each sub-aperture having its own fast-axis alignment. The thickness for each layer is constant across all sub-apertures. The fast axis angles for each division and layer, along with the retardance for the layer, are shown in FIG. 12. FIG. 13 illustrates the raytrace for each of the six unique raypaths through the solid corner cube reflector and the compensator having two layers with the characteristics of FIG. 12. Light that is linearly polarized along the x-axis is input for all raypaths. Each raypath outputs linearly polarized light along the x-axis satisfying the non-polarizing condition.

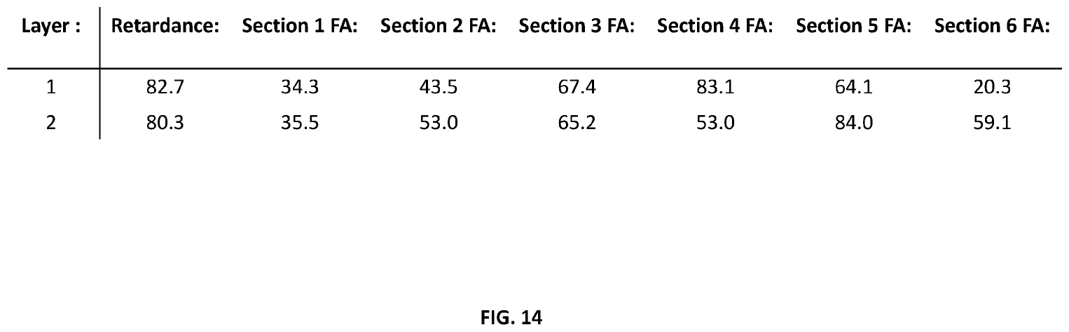

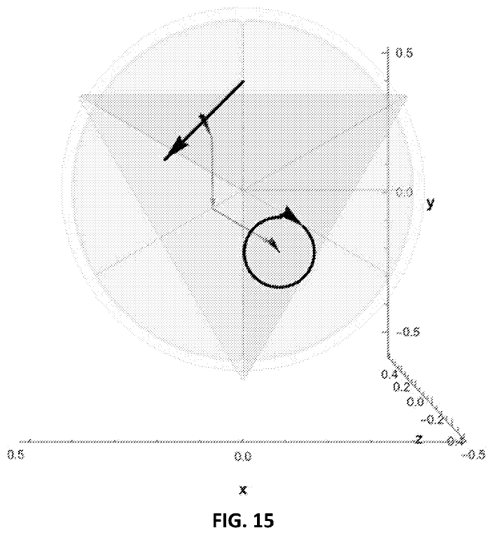

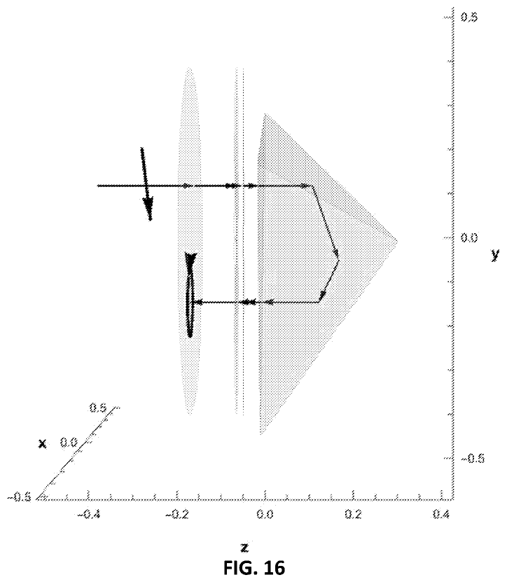

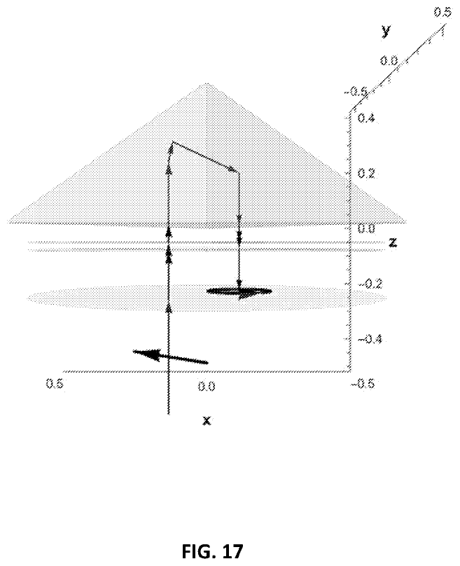

FIG. 14 illustrates an example design for a two-layer compensator allowing the compensated corner cube reflector to operate as a quarter-wave plate (QWP) oriented along the x-axis. The design consists of two layers, with each sub-aperture having its own fast-axis alignment. The thickness for each layer is constant across all sub-apertures. The fast axis angles for each division and layer, along with the retardance for the layer, are shown in FIG. 12. Using this compensator, when a 45 degree linearly polarized light is input, an output circularly polarized light is produced. FIG. 15 shows a top view, and FIGS. 16 and 17 show two different side views of the same raypaths being traced through the corner cube reflector at normal incidence, resulting in the output circularly polarized light. That is, the corner cube reflector and the compensator designed with the prescription of FIG. 14 act as a QWP oriented along the x-axis.

Of interest as well is the angular performance of the design. An eight-degree cone of angles, as was shown in FIG. 6, is traced through for each raypath. The degree of circular polarization (DoCP) is then tabulated for each of the rays traced, where DoCP is defined using the Stokes parameters below and is defined in the range [−1,1]:

$$D o C P = \frac{{S}_{3}}{{S}_{0}} \qquad ( 4 )$$

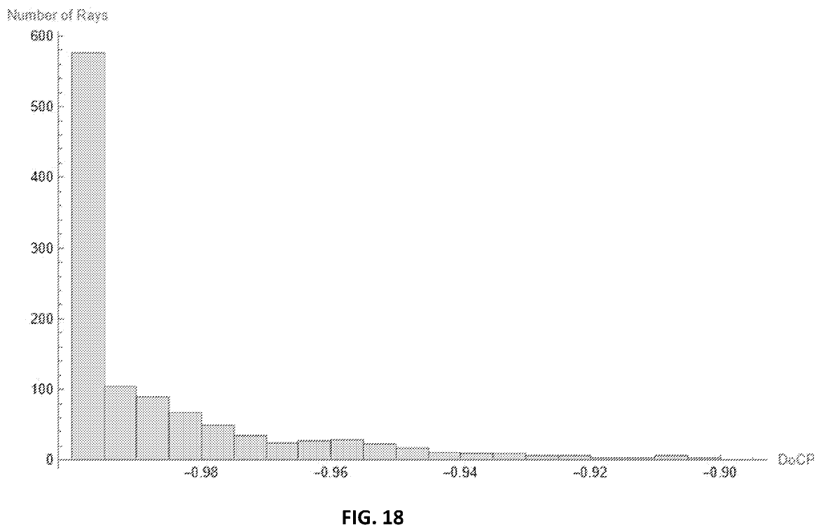

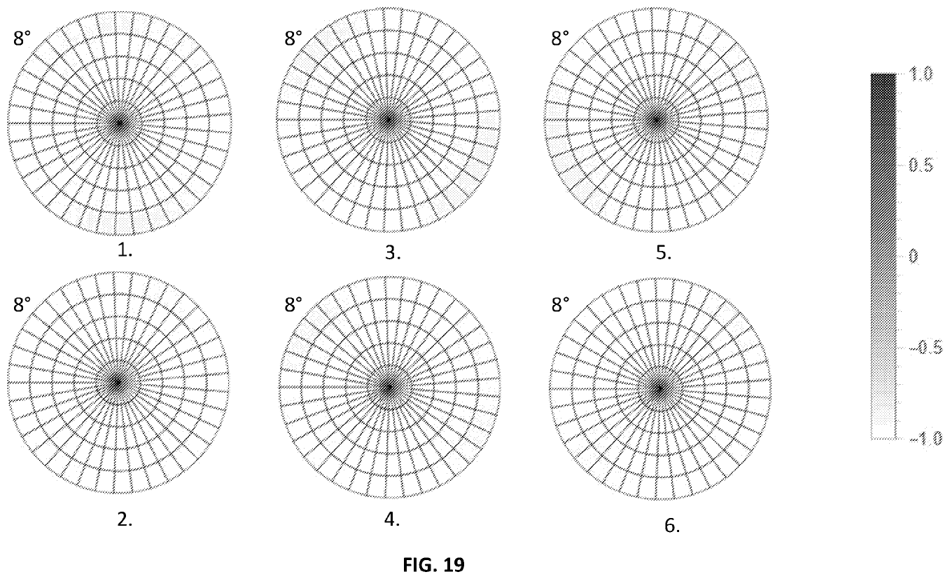

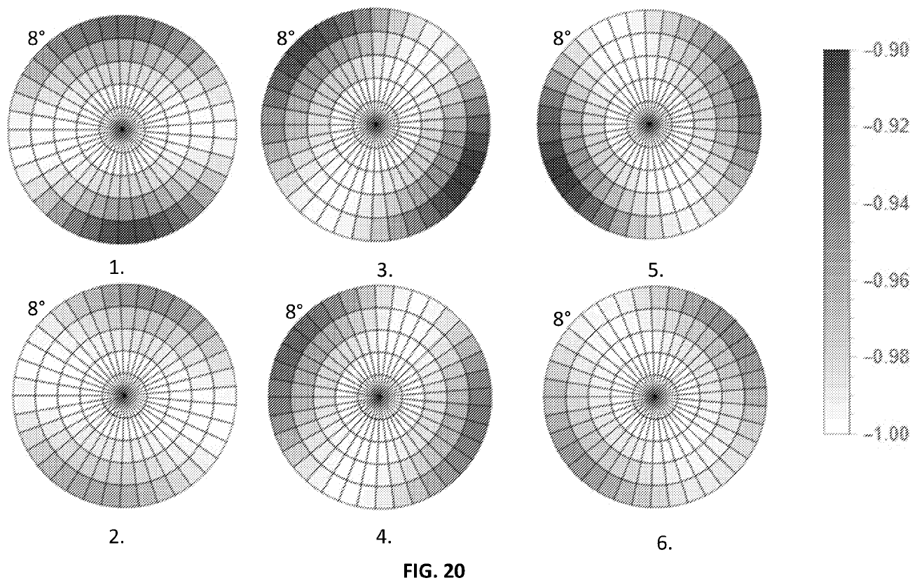

Here S₀ and δ₃ are the first and third component of the Stokes parameters. Histogram of DoCP for the rays is shown in FIG. 18 for each ray traced through the system. In particular, 45° linearly polarized light is input at all apertures with a compensator design acting as a QWP oriented along the x-axis. The compensator technique shows excellent polarization control, where most rays have nearly perfect circular states (i.e., the DoCP of most of the light rays are close to −1, and none are beyond −0.9). FIGS. 19 and 20 show the same results for each raypath in polar form. These plots show the result as if looking into the cone of light that is output from the corner cube reflector-compensator combination. In particular, FIG. 19 shows polar plots of the S₃ Stokes parameter for each raypath, and for up to eight degrees angular incidence. 45° linearly polarized light is input at all apertures, and left hand circular polarized light is output. FIG. 20 is similar to FIG. 19, but has a reduced scale to show certain details of the variation. The plots in FIG. 20 show slight ellipticity at high angles of observation (e.g., the outer annuli with shadow highlights). To increase the angular performance of the device, additional A-plates, C-plates, and O-plates with varying pre-tilt angles can be added to the compensator stack.

In addition to the solid prism corner cube reflectors, hollow corner cube reflectors, utilizing three metallic coated mirrors joined in the same configuration, can be used to retroreflect incident light. Angular input is much larger utilizing hollow corner cube reflector; however, a significant loss of power is found due to the absorption of metal coatings. Polarization aberrations are found with the hollow corner cube reflector as well. Fresnel reflections causing a linear diattenuation and linear retardance are produced at all reflective interfaces. Additionally, geometric transformations from propagation direction change are found. In some embodiments, using the above-described techniques, a multi-segment compensator can be designed and positioned across the entrance of the hollow corner cube reflector to correct both geometrical transformations and polarization aberrations due to linear retardance from the reflective surfaces.

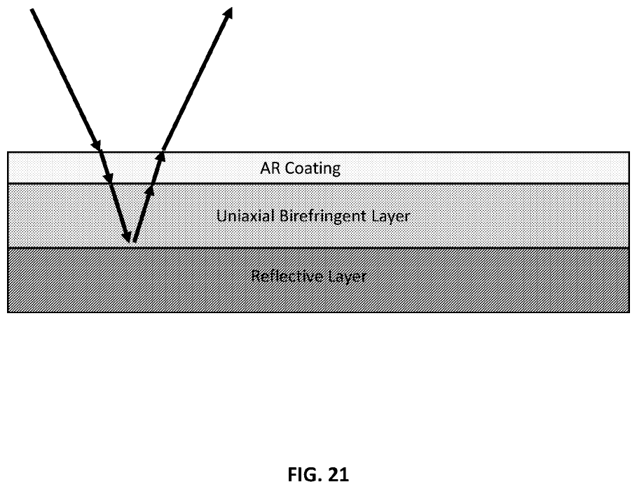

In some embodiment, a combination of techniques can be used to correct both geometrical and polarization aberrations. In particular, to correct the polarization aberrations due to reflection from metals, a coating can be placed on the aluminum mirror to reduce the polarization change due to the reflection from the mirror. For example, a multi-layer structure to compensate for polarization aberrations can include a reflective layer having retardance and diattenuation over a particular range of wavelengths, a uniaxial birefringent layer can be positioned above the reflective layer, where the thickness of the uniaxial birefringent layer can be selected to compensate for at least a portion of the retardance associated with the reflective layer over the particular range of wavelengths. The multi-layer structure also includes an anti-reflection layer that is positioned above the uniaxial birefringent layer. The thickness of the anti-reflection layer can be selected to compensate for at least a portion of the diattenuation associated with the reflective layer over the particular range of wavelengths. The uniaxial birefringent layer and the anti-reflection layer are positioned to allow incident polarized light to pass through the anti-reflection layer and through the uniaxial birefringent layer to reach the reflective layer, and upon reflection from the reflective layer to pass through the uniaxial birefringent layer and then through anti-reflection layer. The uniaxial birefringent layer can be a C-plate and the reflective layer (e.g., aluminum, silver or gold layer) can have an index of refraction that includes a real part and an imaginary part. For example, the reflective layer can have a positive real and imaginary parts of the index of refraction and the uniaxial birefringent layer can be a negative C-plate layer; the reflective layer can have a negative real and imaginary parts of the index of refraction and the uniaxial birefringent layer can be a negative C-plate layer; or the reflective layer can have a real and imaginary parts of the index of refraction that have opposite signs with respect to one another, and the uniaxial birefringent layer can be a positive C-plate. FIG. 21 illustrates an example of such a multi-layer structure that includes an AR coating on top a uniaxial birefringent layer (e.g., C-plate), which is placed above the reflective layer (e.g., metallic layer such as aluminum). The thicknesses of the C-plate, the C-plate material, and the Fresnel reflections associated with the AR coating interface, and the AR coating thickness can be optimized to produce the desired polarization compensation characteristics.

The net geometric transformations of the hollow corner cube reflector is equal to a Mueller matrix of a half-wave plate oriented along the x-axis. Therefore, a polarization compensator in the form of a uniform quarter-wave plate, e.g., with fast-axis also oriented along the x-axis, can be added across the entrance of the hollow corner cube reflector to correct the geometric transformations. In this configuration, all sections of the polarization compensator that receive light prior to entry into, or after exiting the corner cube reflector, have the same fast-axis angle and can have the same thickness. While the coating on the metallic reflective surfaces provides excellent polarization control across a wide spectral and angular bandwidth, the added polarization compensator (e.g., quarter-wave plate) compensates for geometric transformations, which together provide full polarization correction. The added compensator (e.g., quarter-wave plate) can be constructed utilizing A-plates, C-plates, and biaxial plates to increase the angular bandwidth of the hollow corner cube reflector. With the quarter-wave plate and the coating on the mirror, the hollow corner cube reflector can exhibit no polarization aberrations across a 400 nm spectral bandwidth and within a 60-degree angular cone.

In applications where consideration of non-normal angles of incidence important, Eq. (1) can be modified to include non-normal incident angle or range of angles of entry. The disclosed embodiments provide flexible technique that accommodate different input and output polarization states, including linear, elliptical, and circular polarization states. Notably, Eq. (2) can change for an A-plate at varying angles of incidence and is shown in Eq. (5).

$$δ = \frac{2 π}{λ} d [ {n}_{e} \sqrt{1 - \frac{{sin}^{2} {ϕ}_{0} {sin}^{2} ( {θ}_{i} - {θ}_{0} )}{{n}_{e}^{2}} - \frac{{sin}^{2} {ϕ}_{0} {cos}^{2} ( {θ}_{i} - {θ}_{0} )}{{n}_{o}^{2}}} - {n}_{o} \sqrt{1 - \frac{{sin}^{2} {ϕ}_{0}}{{n}_{o}^{2}}} ] \qquad ( 5 )$$

Here nₑ is the extraordinary index of refraction, nₒ is the ordinary index of refraction, θᵢ is the fast-axis orientation, θ₀ is the azimuth angle of incidence, and ϕ₀ is the elevation angle of incidence. Eq. (1) must now account for θ₀ and ϕ₀ in the summation of C.

In some embodiments, the disclosed compensators (or filters) are tiled in an array to match an array of corner cube reflectors. For example, an array of polarization filters can be designed to overlay on a reflector sheet includes closely packed array of corner cube reflectors. While a corner cube reflector is used broadly in the visible and infrared spectrum, the disclosed embodiments can also be applied to ultraviolet light, terahertz radiation, radio wave and microwave, provided that the proper birefringent and low-loss materials are used. Furthermore, the disclosed embodiments are described in the context of corner cube reflectors, which are one types of retroreflectors. It is understood, however, that the disclosed technique can be applied to other types of retroreflectors such as cat's eye reflector and nonlinear retroreflectors. The compensator in such cases can include a low-loss patterned birefringent material with a spatially varying orientation and retardance distribution.

In some embodiments, the compensator can be designed to operate over a range of wavelength. An achromatic compensator will generally have more layers than a simple compensator that operates at a single wavelength. For such design, the dispersion of the glass or the dispersion of the metallic mirror, in addition to the dispersion of the birefringent layer must be taken into account. A method to design and fabricate broadband compensator using liquid crystal polymer is discussed in U.S. Pat. No. 10,254,453, which is included in this patent document as APPENDIX B. For some applications, an antireflection coating can be added to the compensator to reduce optical loss. This coating can be designed to have low or no polarization aberration for the operating wavelength and angle range.

The example compensators described in connection with the various figures in this patent document operate as transmission filters. For some applications, a compensator can be designed to operate as a reflection filter. In this case, a layer of reflective material is added to the compensator, and the six regions of the reflective compensator are aligned with the corner cube reflector, similar to that of the transmissive compensator in FIG. 5.

One aspect of the disclosed embodiments relates to a retroflector system with polarization compensation that includes a corner cube reflector configured to receive input light and produce output light in six unique raypaths, each raypath consisting of three reflections of the input light from a corresponding combination of corner cube reflector surfaces before exiting the corner cube reflector. The retroflector system further includes a polarization compensator positioned in front of the corner cube reflector, the polarization compensator including six sub-apertures that are positioned to allow light associated with each unique raypath to enter one of the sub-apertures before entering the corner cube reflector and to exit another one of the sub-apertures after exiting the corner cube reflector. Each sub-aperture comprises one or more layers comprising birefringent material, each sub-aperture has a different fast axis compared to any other sub-aperture, and each sub-aperture is configured to impart a particular amount of polarization compensation to the light that is incident thereon such that exitant light associated with all unique raypaths has the same output polarization, regardless of which sub-aperture the light exits from, when the input light that enters the polarization compensator has a first polarization.

In one example embodiment, each sub-aperture is configured to impart a different amount of polarization compensation to the light that is incident thereon compared to any other sub-aperture. In another example embodiment, the output polarization is the same as the first polarization. In yet another example embodiment, the output polarization is different from the first polarization. In still another example embodiment, the number of layers in each sub-aperture is two. In another example embodiment, all sub-apertures have the same thickness. In one example embodiment, the retroflector system is configured to receive the input light that spans a cone of angles of incidence. For example, the cone of angles of incidence allows light that enters the corner cube reflector to undergo total internal reflection (TIR). In another example, an angular extent of the cone is less than or equal to 10 degrees.

According to another example embodiment, the birefringent material includes one of a liquid crystal polymer, a metamaterial, a birefringent crystal, uniaxial or biaxial material, or a form birefringent coating. In yet another example embodiment the plurality of layers comprises coatings on a transparent substrate or on a facet of the corner cube reflector. In still another example embodiment, the first polarization is linear, and the output polarization is one of a circular, elliptical or a different linear polarization than the first polarization. In another example embodiment, the compensator is configured to compensate polarization aberrations due to both reflections of light and change of direction of propagation of light.

In another example embodiment, the retroflector system is configured to operate in one of the following spectral ranges of the input light: infrared, visible, ultraviolet, terahertz, radio wave or microwave. In one example embodiment, the corner cube reflector is solid prism corner cube reflector. In still another example embodiment, the corner cube reflector is a hollow corner cube reflector with internal surfaces that include a reflective coating.

Another aspect of the disclosed embodiments relates to a retroflector system with polarization compensation that includes a hollow corner cube reflector configured to receive input light and produce output light in six unique raypaths, each raypath consisting of three reflections of the input light from a corresponding combination of corner cube reflector reflective surfaces before exiting the corner cube reflector. Each of the reflective surfaces includes a coating that is configured to compensate for at least a portion of polarization aberrations due to linear retardance generated by reflection of light from the reflective surface of the hollow corner cube reflector. The retroflector system also includes a polarization compensator positioned in front of the hollow corner cube reflector, the polarization compensator allows light associated with each unique raypath to enter one of sections of the polarization compensator before entering the corner cube reflector and to exit another section of the polarization compensator after exiting the hollow corner cube reflector. The polarization compensator comprises one or more layers comprising birefringent material, and each section of the polarization compensator is configured to impart an amount of polarization compensation to the light to compensate for at least a portion of polarization aberrations due to a change of direction of light upon reflection. Additionally, the combination of polarization compensations by the coating and the polarization compensator allows exitant light associated with all unique raypaths to have the same output polarization, regardless of which section of the polarization compensator the light exits from, when the input light that enters the polarization compensator has a first polarization.

In one example embodiment, all sections of the polarization compensator have the same fast axis orientation. In another example embodiment, the polarization compensator has the same thickness across all sections thereof. In still another example embodiment, the retroflector system is configured to receive the input light that spans a cone of angles of incidence. In another example embodiment, the reflective surfaces include a metal layer, and the coating on each reflective surface is configured to minimize or reduce absorption of light that is incident on the reflective surface. According to another example embodiment, the retroflector system is configured to operate with a 400 nm spectral bandwidth and within a 60-degree angular cone of acceptance. In another example embodiment, the polarization compensator is a uniform wave plate.

It is understood that the various disclosed embodiments may be implemented individually, or collectively, using devices comprised of various optical components, electronics hardware and/or software modules and components. These devices, for example, may comprise a processor, a memory unit, an interface that are communicatively connected to each other, and may range from desktop and/or laptop computers, to mobile devices and the like. The processor and/or controller can perform various disclosed operations based on execution of program code that is stored on a storage medium. The processor and/or controller can, for example, be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. For example, the processor may be configured to determine the numbers and thicknesses of the layers for the disclosed compensators for a range of angles of incidence and/or wavelength based on the techniques disclosed herein.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

What is claimed is:

1. A retroflector system with polarization compensation, comprising:
a corner cube reflector configured to receive input light and produce output light in six unique raypaths, each raypath consisting of three reflections of the input light from a corresponding combination of corner cube reflector surfaces before exiting the corner cube reflector;
a polarization compensator positioned in front of the corner cube reflector, the polarization compensator including six sub-apertures that are positioned to allow light associated with each unique raypath to enter one of the sub-apertures before entering the corner cube reflector and to exit another one of the sub-apertures after exiting the corner cube reflector, wherein:
each sub-aperture comprises one or more layers comprising birefringent material,
each sub-aperture has a different fast axis compared to any other sub-aperture, and
each sub-aperture is configured to impart a particular amount of polarization compensation to the light that is incident thereon such that exitant light associated with all unique raypaths has the same output polarization, regardless of which sub-aperture the light exits from, when the input light that enters the polarization compensator has a first polarization.

2. The retroflector system of claim 1, wherein each sub-aperture is configured to impart a different amount of polarization compensation to the light that is incident thereon compared to any other sub-aperture.

3. The retroflector system of claim 1, wherein the output polarization is the same as the first polarization.

4. The retroflector system of claim 1, wherein the output polarization is different from the first polarization.

5. The retroflector system of claim 1, wherein the number of layers in each sub-aperture is two.

6. The retroflector system of claim 1, wherein all sub-apertures have the same thickness.

7. The retroflector system of claim 1, configured to receive the input light that spans a cone of angles of incidence.

8. The retroflector system of claim 7, wherein the cone of angles of incidence allows light that enters the corner cube reflector to undergo total internal reflection (TIR).

9. The retroflector system of claim 8, wherein an angular extent of the cone is less than or equal to 10 degrees.

10. The retroflector system of claim 1, wherein the birefringent material includes one of a liquid crystal polymer, a metamaterial, a birefringent crystal, uniaxial or biaxial material, or a form birefringent coating.

11. The retroflector system of claim 1, wherein the plurality of layers comprises coatings on a transparent substrate or on a facet of the corner cube reflector.

12. The retroflector system of claim 1, wherein the first polarization is linear, and the output polarization is one of a circular, elliptical or a different linear polarization than the first polarization.

13. The retroflector system of claim 1, wherein the compensator is configured to compensate polarization aberrations due to both reflections of light and change of direction of propagation of light.

14. The retroflector system of claim 1, configured to operate in one of the following spectral ranges of the input light: infrared, visible, ultraviolet, terahertz, radio wave or microwave.

15. The retroflector system of claim 1, wherein the corner cube reflector is solid prism corner cube reflector.

16. The retroflector system of claim 1, wherein the corner cube reflector is a hollow corner cube reflector with internal surfaces that include a reflective coating.

17. A retroflector system with polarization compensation, comprising:
a hollow corner cube reflector configured to receive input light and produce output light in six unique raypaths, each raypath consisting of three reflections of the input light from a corresponding combination of corner cube reflector reflective surfaces before exiting the corner cube reflector, wherein:
each of the reflective surfaces includes a coating that is configured to compensate for at least a portion of polarization aberrations due to linear retardance generated by reflection of light from the reflective surface of the hollow corner cube reflector;
a polarization compensator positioned in front of the hollow corner cube reflector, the polarization compensator to allow light associated with each unique raypath to enter one of sections of the polarization compensator before entering the corner cube reflector and to exit another section of the polarization compensator after exiting the hollow corner cube reflector, wherein:
the polarization compensator comprises one or more layers comprising birefringent material,
each section of the polarization compensator is configured to impart an amount of polarization compensation to the light to compensate for at least a portion of polarization aberrations due to a change of direction of light upon reflection, and
the combination of polarization compensations by the coating and the polarization compensator allows exitant light associated with all unique raypaths to have the same output polarization, regardless of which section of the polarization compensator the light exits from, when the input light that enters the polarization compensator has a first polarization.

18. The retroflector system of claim 17, wherein all sections of the polarization compensator have the same fast axis orientation.

19. The retroflector system of claim 17, wherein the polarization compensator has the same thickness across all sections thereof.

20. The retroflector system of claim 17, configured to receive the input light that spans a cone of angles of incidence.

21. The retroflector system of claim 17, wherein the reflective surfaces include a metal layer, and the coating on each reflective surface is configured to minimize or reduce absorption of light that is incident on the reflective surface.

22. The retroflector system of claim 17, configured to operate with a 400 nm spectral bandwidth and within a 60-degree angular cone of acceptance.

23. The retroreflector system of claim 17, wherein the polarization compensator is a uniform wave plate.
